(19) United States
(12) Patent Application Publication
(10) Pub. No.: US 2025/0167268 A1
(43) Pub. Date: May 22, 2025

(54) Anodic Purging Method and System for Fuel Cell of Vehicle, and Fuel Cell

(71) Applicant: Robert Bosch GmbH, Stuttgart (DE)

(72) Inventors: Yongcui Ma, Wuxi (CN); Wei Ding, Wuxi (CN); Zheng Shen, Wuxi (CN)

(21) Appl. No.: 18/940,337

(22) Filed: Nov. 7, 2024

(30) Foreign Application Priority Data
Nov. 17, 2023 (CN) 2023 1154 2625.6

(51) Int. Cl. H01M 8/04223; B60L 58/31; H01M 8/04225

(52) U.S. Cl. CPC H01M 8/04231; B60L 58/31; H01M 8/04225; H01M 2250/20

(57) ABSTRACT

An anodic purging method for a fuel cell, in particular a hydrogen fuel cell of a vehicle, is disclosed. Anodic purging is performed with a preset anodic purging duration during first start of the fuel cell, and the anodic purging method includes (i) detecting a power-on state of the vehicle, (ii) detecting a shutdown duration of the fuel cell after the start in the power-on state of the vehicle, and (iii) adapting an anodic purging duration of the fuel cell during restart in case of taking the shutdown duration into account. Also disclosed is a respective anodic purging system, a fuel cell, and a computer program product. The method and system is capable of adapting to the anodic purging duration of the fuel cell during restart based on the downtime duration after temporary shutdown of the fuel cell, thereby being capable of saving purging hydrogen, and being capable of responding quickly to driver's requirements for start of the vehicle and improving user experience.

This application claims priority under 35 U.S.C. § 119 to patent application no. CN 2023 1154 2625.6, filed on Nov. 17, 2023 in China, the disclosure of which is incorporated herein by reference in its entirety.

The present disclosure relates to the technical field of fuel cells, in particular, to an anodic purging method for a fuel cell, in particular a hydrogen fuel cell of a vehicle, and a respective anodic purging system. The present disclosure also relates to a respective fuel cell and a computer program product.

### BACKGROUND

As the development of new energy vehicles, fuel cells have been applied to passenger vehicles as power sources.

Electrical energy is generated by an electrochemical reaction of hydrogen with oxygen in a fuel cell, especially a proton exchange membrane fuel cell (PEMFC). While a fuel cell stack is in operation, hydrogen undergoes an electrochemical reaction at an anode, and air undergoes an electrochemical reaction at a cathode. When the fuel cell is shut down and runs again, there is a need to purge the anode of the fuel cell stack. The anode is typically purged with hydrogen, thereby expelling materials (for example, oxygen, nitrogen, and liquid water, etc.) from anode runners and tubes, in order to prevent “air-air start” during restart of the fuel cell. The fuel cell stack does not output power in the purging process.

However, after the fuel cell has been shut down for a short period of time, for example in case that the fuel cell is restarted after a vehicle waits for the extinguishing of a red light at an intersection or is parked temporarily, anodic purging is performed on the fuel cell with a fixed anodic purging duration all the time. This can result in the fuel cell being unable to respond quickly to the start of the vehicle or a start need of a driver, which may result in slow start of the vehicle and affect the user experience.

Further, since the anode is purged with hydrogen with a fixed duration, the amount of hydrogen for purging is not adjustable for different shutdown situations, which results in waste of the amount of hydrogen for purging.

As a result, there is still a need for improving the above solutions to address numerous deficiencies in the prior art.

### SUMMARY

In order to overcome one of the above shortcomings and/or other possible deficiencies in the prior art not mentioned herein, a purpose of the present disclosure is to provide an improved anodic purging method for a fuel cell of a vehicle, a respective improved anodic purging system, an improved fuel cell, and a computer program product.

According to a first aspect of the present disclosure, there is provided an anodic purging method for a fuel cell, in particular to a hydrogen fuel cell of a vehicle, wherein anodic purging is performed with a preset anodic purging duration during first start of the fuel cell, and the anodic purging method comprises the following steps:
S110: detecting a power-on state of the vehicle;
S120: detecting a shutdown duration of the fuel cell after the start in the power-on state of the vehicle;
and S130: adapting an anodic purging duration during restart of the fuel cell in case of taking the shutdown duration into account.

The basic idea of the present disclosure is that, by way of improved logical design, in case of power-on of the vehicle, the anodic purging duration during restart of the fuel cell is adaptively adjusted according to the (temporary) shutdown duration of the fuel cell, thereby being capable of adapting the response time of fuel cell power output according to different shutdown (vehicle) conditions of the fuel cell or vehicle, improving the use experience of users and saving the amount of hydrogen for anodic purging.

According to a second aspect of the present disclosure, there is provided an anodic purging system for a fuel cell, in particular a hydrogen fuel cell, of a vehicle.

According to a third aspect of the present disclosure, there is provided a fuel cell, in particular to a hydrogen fuel cell of a vehicle, the fuel cell comprising the anodic purging system of the present disclosure.

According to a fourth aspect of the present disclosure, there is provided a computer program product, in particular to a computer-readable storage carrier, the computer program product comprising computer instructions which, when executed by a processor, are used for at least assisting in executing the anodic purging method of the present disclosure.

The advantageous configuration of the technical solutions of the present disclosure can be obtained from optional examples.

More features of the present disclosure become apparent from the claims, the accompanying drawings, and the description of the accompanying drawings. The features and combinations of features referred to in the above description and/or those mentioned in the following description of the accompanying drawings and/or the features and combinations of features only shown in the accompanying drawings may be used not only in the corresponding designated combinations, but also in other combinations without departing from the scope of the present disclosure. Therefore, the following content is also considered to be covered and disclosed by the present disclosure: the content is not expressly shown in the accompanying drawings and are not expressly explained, but rather derived from and produced from combinations of separate features in the explained content. The following combinations of content and features are also considered to be disclosed: it does not have all of the features of the original written independent claims. Further, the following combination of content and features is considered to be disclosed particularly above: it exceeds or deviates from the combination of features defined in the citation of the claims.

### BRIEF DESCRIPTION OF THE DRAWINGS

Other optional details and features of the present disclosure are obtained from the following description of preferred examples shown schematically in the accompanying drawings.

FIG. 1 shows a flow chart of an anodic purging method for a fuel cell of a vehicle according to one example of the present disclosure; and

FIG. 2 shows a schematic diagram of a control strategy for an anodic purging method of a fuel cell.

### DETAILED DESCRIPTION

To provide a clearer understanding of the technical problems, technical solutions, and beneficial technical effects to be addressed by the present disclosure, the following detailed description of the present disclosure will be provided with reference to the accompanying drawings and multiple exemplary examples. It should be understood that the specific examples described herein are provided solely for the purpose of explaining the present disclosure and not for limiting the scope of protection of the present disclosure.

Further, the features in the examples of the present disclosure may be combined with one another without conflict. The same components are indicated by the same reference numbers in different accompanying drawings, and other components are omitted for simplicity, but this does not indicate that the technical solutions of the present disclosure cannot include other components. It should be understood that the dimensions, the proportional relationship and the number of various components in the accompanying drawings are not a limitation to the present disclosure.

In the prior art, an anode and a cathode of a hydrogen fuel cell need to be purged in case that the hydrogen fuel cell is restarted after shutdown. When the anode of the hydrogen fuel cell is purged, an anode area is purged with hydrogen, thereby purging materials in runners, for example, air and moisture infiltrating from the cathode, and the runners are filled with hydrogen. Therefore, “air-air start” during restart of the fuel cell is prevented.

However, in the prior art, anodic purging is performed with a fixed anodic purging duration for each start all the time, on one hand, the rapid response to power demands when the user restarts the fuel cell after for example, temporary parking cannot be met, and on the other hand, the fixed anodic purging duration results in excessive consumption of hydrogen for anodic purging.

Accordingly, the examples of the technical solutions of the present disclosure are explained in detail below with reference to the accompanying drawings for the shortcomings of the prior art.

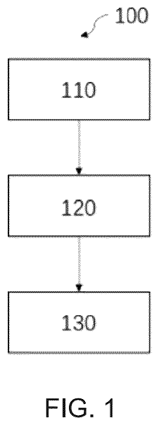

FIG. 1 shows a flow chart of an anodic purging method 100 for a fuel cell of a vehicle according to one example of the present disclosure. The anodic purging method of this example exemplarily comprises method steps S110 to S130.

In this example, the vehicle is configured as a vehicle driven by a fuel cell. The fuel cell is exemplarily configured as a proton exchange membrane hydrogen fuel cell. Since the construction and working principles of the hydrogen fuel cell are already well known in the prior art, they are not described in detail herein.

As shown in FIG. 1, in method step S110, a power-on state T15 of a vehicle is detected. In the present disclosure, the “power-on state” can be understood as the driver inserting a vehicle key into a key switch of the vehicle. This means that a vehicle controller VCU is “awaken” when the vehicle is powered on and is capable of controlling various components of the vehicle through a vehicle bus CAN.

In method step S120, in the power-on state of the vehicle, the shutdown duration after the start of the fuel cell is detected. In case that the vehicle is powered on again after being powered off, for example, the driver returns home and restarts the vehicle on alternate days, the fuel cell is first started and anodic purging is performed with a preset anodic purging duration T. The preset anodic purging duration T is stored, for example, in the fuel cell controller FCCU.

When the driver parks the vehicle temporarily, for example, the fuel cell is shut down and does not output power (no electrochemical reaction occurs). During shutdown of the fuel cell, the fuel cell shutdown duration is detected or recorded.

Next, in method step S130, the anodic purging duration during restart of the fuel cell is adapted in case of taking the detected downtime duration into account.

In this example, the anodic purging duration during restart of the fuel cell may be adapted or changed depending on the fuel cell shutdown duration. This enables a particularly flexible and adaptive response to power output needs of the user for the fuel cell. In addition, the adaptive change in the anodic purging duration can also adapt to the amount of hydrogen for anodic purging, thereby being capable of saving the amount of hydrogen used and increasing the economic efficiency.

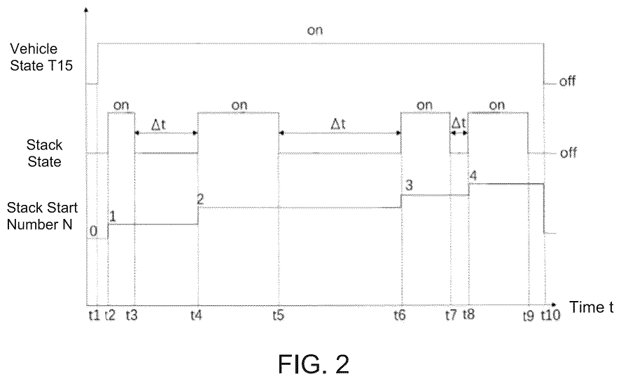

Next, an example of the anodic purging method 100 of the present disclosure is further set forth in connection with FIG. 2.

FIG. 2 shows a schematic diagram of a control strategy for an anodic purging method 100 for a fuel cell. As shown in FIG. 2, X-Y coordinates are shown, wherein X coordinates represent time, and Y coordinates represent a vehicle state T15, a stack state, and a stack start number N, respectively, wherein T15 represents the power-on state of the vehicle.

The stack start number N represents a number of restarts after each stack shutdown. The stack working state on and the shutdown state off are shown in the stack state, wherein the shutdown duration during each shutdown of the fuel cell stack is exemplarily indicated in time Δt.

Also in connection with FIG. 1, according to one example, in method step S110, the power-on state T15 of the vehicle is detected. The power-on state T15 of the vehicle is shown in the form of an electrical potential in FIG. 2; and at time t1, the driver inserts the vehicle key into a key switch, for example, the vehicle is powered on, and T15=on. Here, the vehicle controller VCU is capable of controlling various components of the vehicle through the vehicle bus CAN.

According to this example, the vehicle performs anodic purging during the first start with the preset anodic purging duration T. Here, the preset anodic purging duration T is, for example, 10 s and is stored in the fuel cell controller FCCU. As shown in FIG. 2, in the power-on state of the vehicle, the fuel cell stack is started at the time point t2 for the first time. Here, hydrogen is used to purge the anode of the fuel cell with a preset anodic purging duration T, for example 10 s. In this anodic purging process, the fuel cell stack does not undergo an electrochemical reaction and does not output power (electrical energy). The fuel cell stack start number N=1.

In method step S120, in the power-on state of the vehicle, the shutdown duration of the fuel cell after the start is detected.

According to one example, the shutdown duration Δt of the fuel cell after the first start is detected. As shown in FIG. 2, Δt−t4−t3. According to this example, a first reference shutdown duration tri is set, and the first reference shutdown duration tri characterizes a reference shutdown duration for one shutdown of the fuel cell. Exemplarily, tᵣ₁ is 60 s. In this example, if At is less than tᵣ₁, in method step S130, anodic purging is performed with less than the preset anodic purging duration T during second start of the fuel cell stack N=2, thereby shortening the purging time and accordingly reducing the amount of hydrogen for purging. If Δt is greater than or equal to tᵣ₁, in method step S130, anodic purging is performed with the preset anodic purging duration T during second start of the fuel cell stack N=2. As a result, the respective anodic purging duration is adapted for different shutdown durations, which increases the speed of response to the driver's vehicle start and power output requirements. The driver gains a quick power response, for example, when stepping on a throttle pedal, thereby improving the user experience.

According to one example, the anodic purging duration T(N) is adapted in a manner of being proportional to the preset anodic purging duration. That is, for example, if Δt(t4−t3) is less than tᵣ₁, the anodic purging duration is adapted to T(2)=a·T during the second start of the fuel cell stack N=2, wherein a is a proportion and is greater than 0 and less than 1. In this example, the proportion a may be preset.

According to a further example, the proportion a is a ratio of each shutdown duration Δt to the first reference shutdown duration tᵣ₁. Thus, during the second start of the fuel cell stack N=2, the anodic purging duration is T(2)=(t4−t3)·T/tᵣ₁. Exemplarily, if it is detected that t4−t3=30 s, and tᵣ₁=60 s , T=10 s, the anodic purging duration during the second start of the fuel cell stack is shortened to 5 s.

That is, the shorter each shutdown duration of the fuel cell, the shorter the anodic purging duration during restart of the fuel cell. This enables the anodic purging duration of this start to be adapted according to the last shutdown duration, thereby being capable of further saving the amount of hydrogen used in case of preventing “air-air start”.

In this example, the method steps S110 to S130 of the method 100 of the present disclosure may be repeated for each shutdown (start) of the fuel cell. According to this example, the adaptation to the anodic purging duration at this start is based on the last shutdown duration.

As also shown in FIG. 2, for example, the fuel cell is shut down at time point t5 after the second start and the downtime duration is Δt=t6−t5. As visualized in FIG. 2, the second shutdown duration of the fuel cell is clearly greater than the first shutdown duration and is exemplarily greater than the first reference shutdown duration tᵣ₁, so during the third start of the fuel cell N=3, anodic purging is performed with the preset anodic purging duration T(3)=T.

As also shown in FIG. 2, for the fourth start of the fuel cell after shutdown N=4, the shutdown duration Δt=t8−t7, as visualized in FIG. 2, the shutdown duration is much smaller than the previous shutdown duration, which means that the driver only parks the vehicle for a short period of time, e.g., waits for pedestrians to cross the road in front of a sidewalk. According to another example, a second reference shutdown duration tᵣ₂ may also be set. In method step S130, the anodic purging duration T(N) at subsequent start is adapted by additionally comparing the downtime duration Δt to tᵣ₁ and tᵣ₂, respectively. In this example, tᵣ₂ is less than tᵣ₁. Exemplarily, the second reference shutdown duration tᵣ₂, is 5 s, and if Δt(t8−t7) is less than tr2=5 s , anodic purging is not performed during the fourth start of the fuel cell (time point t8) in method step S130. This further improves the power response speed of the fuel cell in a flexible and adaptable manner, improves the user experience and further saves the amount of hydrogen used.

In FIG. 2, at time point t10, the vehicle is powered off T15=off. Thus, the method of the present disclosure ends, and the anodic purging duration T(N) is reset to the preset anodic purging duration T; and the stack start number N is reset to 0.

The present disclosure also relates to an anodic purging system for a fuel cell, in particular to a hydrogen fuel cell, which is capable of implementing the anodic purging method 100 described above. In addition, the present disclosure also relates to a fuel cell, in particular to a hydrogen fuel cell comprising the anodic purging system described above.

Technical solutions of the present disclosure are exemplarily applied to a vehicle and applied to a hydrogen fuel cell. However, other application fields of the fuel cell may also be considered, as long as the technical idea of the present disclosure is used and respective technical advantages are achieved.

In the Specification, the statement of “first,” “second,” etc., is used for descriptive purposes only and should not be construed as indicating or implying relative importance. Furthermore, such terms should not be understood as implying a quantity of the indicated technical features. Features described with “first,” “second,” etc., can explicitly or implicitly represent the inclusion of at least one of those features. For those skilled in the art, the meaning of the above terms in the present disclosure may be understood as appropriate.

What is claimed is:

1. An anodic purging method for a fuel cell of a vehicle, wherein anodic purging is performed with a preset anodic purging duration during first start of the fuel cell, and the anodic purging method comprises:
(a) detecting a power-on state of the vehicle;
(b) detecting a shutdown duration of the fuel cell after the start in the power-on state of the vehicle; and
(c) adapting an anodic purging duration of the fuel cell during restart in case of taking the shutdown duration into account.

2. The anodic purging method according to claim 1, wherein a first reference shutdown duration is set,
if the detected shutdown duration is less than the first reference shutdown duration, in step (c), anodic purging is performed with the anodic purging duration less than the preset anodic purging duration; and/or
if the detected shutdown duration is greater than or equal to the first reference shutdown duration, in step (c), anodic purging is performed with the preset anodic purging duration.

3. The anodic purging method according to claim 2, wherein in step (c), the anodic purging duration is adapted in a manner of being proportional to the preset anodic purging duration.

4. The anodic purging method according to claim 3, wherein a proportion is a ratio of each detected shutdown duration to the first reference shutdown duration.

5. The anodic purging method according to claim 1, wherein step (a) to step (c) are repeated.

6. The anodic purging method according to claim 2, wherein a second reference shutdown duration is set, the second reference shutdown duration is less than the first reference shutdown duration, and if the detected shutdown duration is less than the second reference shutdown duration, anodic purging is not performed in step (c).

7. The anodic purging method according to claim 1, wherein adaptation to the anodic purging duration of this start is based on a last shutdown duration.

8. The anodic purging method according to claim 1, wherein an anode of the fuel cell is purged with hydrogen.

9. The anodic purging method according to claim 8, wherein:
the preset anodic purging duration is 10 s; and/or
the first reference shutdown duration is 60 s; and/or
the second reference shutdown duration is 5 s.

10. An anodic purging system for a fuel cell of a vehicle, the anodic purging system being configured for implementing the anodic purging method according to claim 1.

11. A fuel cell of a vehicle, comprising the anodic purging system according to claim 10.

12. A computer program product comprising computer instructions which, when executed by a processor, are used for at least assisting in executing the anodic purging method according to claim 1.

13. The anodic purging method according to claim 1, wherein the fuel cell is a hydrogen fuel cell.

14. The anodic purging system according to claim 10, wherein the fuel cell is a hydrogen fuel cell.

15. The fuel cell according to claim 11, wherein the fuel cell is a hydrogen fuel cell.
